(19) United States
(12) Patent Application Publication
(10) Pub. No.: US 2025/0354029 A1
(43) Pub. Date: Nov. 20, 2025

(54) TWO-COMPONENT MIXED POLYUREA RESIN COMPOSITION PRODUCTION RAW MATERIAL AND POLYUREA RESIN COMPOSITION

(71) Applicant: UNITIKA LTD., Osaka-shi, Osaka (JP)

(72) Inventor: Shohei SAKASHITA, Uji-shi, Kyoto (JP)

(73) Assignee: UNITIKA LTD., Osaka-shi, Osaka (JP)

(21) Appl. No.: 18/872,574

(22) PCT Filed: Jun. 6, 2023
(86) PCT No.: PCT/JP2023/020972

§ 371 Date: Dec. 6, 2024

(30) Foreign Application Priority Data
Jun. 9, 2022 (JP) 2022-093415
Mar. 28, 2023 (JP) 2023-050926

(51) Int. Cl. C09D 175/02; C08G 18/12; C08G 18/38; C08G 18/50; C08G 18/72; C08G 18/73; C08G 18/76; C08G 18/78

(52) U.S. Cl. CPC C09D 175/02; C08G 18/12; C08G 18/3825; C08G 18/5033; C08G 18/724; C08G 18/73; C08G 18/7614; C08G 18/7635; C08G 18/7831; C08G 18/7893

(57) ABSTRACT

A two-component mixed polyurea resin composition production raw material containing a component (A) that contains a polyisocyanate compound (a) and a component (B) that contains an aromatic polyamine compound (b), wherein the two-component mixed polyurea resin composition production raw material is characterized in that the usable time from immediately after component (A) and component (B) are mixed until the viscosity value measured in an organic-solvent-free state doubles is 10 minutes or longer.

### TECHNICAL FIELD

The present invention relates to a two-component mixed polyurea resin composition production raw material and a polyurea resin composition.

### BACKGROUND ART

Conventionally, a polyurea resin has been used as a reinforcing material for aged buildings and frameworks and as a material for imparting durability against natural disasters such as earthquakes because it has superior physical properties and can be used without a solvent.

The isocyanate component and the amine component, which serve as raw materials of the polyurea resin, react very quickly, and therefore, these raw material compounds are conventionally mixed using a collision mixing type spray device, and sprayed and applied in the application of the polyurea resin.

On the other hand, because a spray device cannot be used in application in a closed space, application to a complicated shape, and so on, a polyurea resin that can be used in application by manual operation (hereinafter, referred to as manual application) and that has a long usable time has been developed.

As a polyurea resin composition in which reactivity between an amine component and an isocyanate component is reduced and a curing time after mixing is secured, for example, Patent Literature 1 discloses a polyurea resin obtained by reacting an amine having a polyalkylene, a polyalkylene ether or an alkylene polyester and having an amino group bonded to an aromatic ring, with a polyisocyanate.

### CITATION LIST

### Patent Literature

PTL 1: Japanese Patent Publication No. S60-32641

### SUMMARY OF INVENTION

### Technical Problem

However, the polyurea resin disclosed in Patent Literature 1 may not have the usable time long enough for manual application, and a coating film obtained by coating may have poor thickness uniformity, or may have insufficient wall surface coatability because a coating liquid drips when applied to a wall surface.

The present invention is intended to solve these problems, and an object of the present invention is to provide a polyurea resin composition and a two-component mixed polyurea resin composition production raw material, which have the usable time allowing manual application work, are superior in thickness uniformity and wall surface coatability during application, and can form a coating film with less yellowing.

### Solution to Problem

The present inventors have found that the above problems can be solved by using an isocyanate having a specific structure and an aromatic polyamine compound having a specific structure, and have accomplished the present invention. That is, the gist of the present invention is as follows.

The two-component mixed polyurea resin composition production raw material of the present invention is characterized in that a component (A) containing a polyisocyanate compound (a) and a component (B) containing an aromatic polyamine compound (b) are contained, and the two-component mixed polyurea resin composition production raw material has the usable time until a viscosity value becomes twice a viscosity value measured in an organic-solvent-free state immediately after mixing the component (A) with the component (B) of 10 minutes or more.

According to the two-component mixed polyurea resin composition production raw material of the present invention, it is preferable that the polyisocyanate compound (a) contains an aliphatic polyisocyanate compound or a derivative thereof in an amount of more than 50% by mass, and the aromatic polyamine compound (b) contains a compound represented by the following general formula (1):

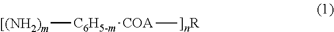

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

According to the two-component mixed polyurea resin composition production raw material of the present invention, the polyisocyanate compound (a) preferably has a viscosity of 3,000 mPa·s or less at 25° C.

According to the two-component mixed polyurea resin composition production raw material of the present invention, the polyisocyanate compound (a) preferably has an isocyanate group content of 5 to 30% NCO.

The polyurea resin composition of the present invention contains a component (A) containing a polyisocyanate compound (a) and a component (B) containing an aromatic polyamine compound (b), wherein all of the following conditions (1) to (3) are satisfied:
(1) the usable time until a viscosity value becomes twice a viscosity value measured in an organic-solvent-free state immediately after mixing the component (A) with the component (B) is 10 minutes or more;
(2) the polyisocyanate compound (a) has a viscosity of 3,000 mPa-s or less at 25° C.;
(3) the polyisocyanate compound (a) contains an aliphatic isocyanate compound or a derivative thereof.

According to the polyurea resin composition of the present invention, the thixotropic index (TI) is preferably 2 to 30.

According to the polyurea resin composition of the present invention, it is preferable that the polyisocyanate compound (a) contains an aliphatic polyisocyanate compound or a derivative thereof in an amount of more than 50% by mass, and the aromatic polyamine compound (b) contains a compound represented by the following general formula (1):

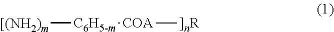

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; in represents an integer of 1 to 3, and n represents an integer of 2 to 4.

According to the polyurea resin composition of the present invention, the polyisocyanate compound (a) preferably has an isocyanate group content of 5 to 30% NCO.

According to the polyurea resin composition of the present invention, it is preferable that the polyurea resin composition further contains an organic solvent, and a content of the organic solvent in the polyurea resin composition is 10% by mass or less.

The method for producing a polyurea resin composition of the present invention is characterized by including mixing a component (A) containing a polyisocyanate compound (a) containing an aliphatic polyisocyanate compound or a derivative thereof in an amount of more than 50% by mass with a component (B) containing an aromatic polyamine compound (b) represented by the following general formula (1):

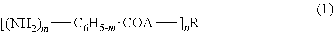

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

The coating material of the present invention is characterized by containing the polyurea resin composition described above.

The coating method of the present invention is characterized by including: preparing a coating material by mixing a component (A) containing a polyisocyanate compound (a) containing an aliphatic polyisocyanate compound or a derivative thereof in an amount of more than 50% by mass with a component (B) containing an aromatic polyamine compound (b) represented by the following general formula (1); and applying the prepared coating material to an object to be coated,

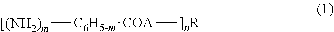

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

According to the coating method of the present invention, the method of applying the coating material is preferably brush coating, roller coating, or trowel coating.

The coating film of the present invention is characterized by being the above-described coating material applied.

### Effects of Invention

The two-component mixed polyurea resin composition production raw material of the present invention has a good usable time without being diluted with an organic solvent or the like, and is also superior in coatability to a wall surface. In addition, the resulting coating film is superior in the uniformity of the thickness of the coating film and has little yellowing, and therefore, a substrate can be visually and physically protected for a long period of time without peeling off from the substrate or causing cracking even in applications with exposure to rainwater or sunlight for a long time.

### DESCRIPTION OF EMBODIMENTS

### <Polyurea Resin Composition>

The polyurea resin composition in the present invention contains a component (A) containing a polyisocyanate compound (a) and a component (B) containing an aromatic polyamine compound (b).

In the present invention, the polyisocyanate compound (a) constituting the resin composition is a compound having two or more isocyanate groups in one molecule, and the form thereof may be any of a monomer, an oligomer, and a polymer.

The polyisocyanate compound (a) preferably contains an aliphatic polyisocyanate compound or a derivative thereof in an amount of more than 50% by mass. Owing to the polyisocyanate compound (a) containing the aliphatic polyisocyanate compound or the derivative thereof in an amount of more than 50% by mass, the reactivity with the aromatic polyamine compound (b) is suppressed, and a time until curing can be secured. In addition, a resulting coating film is uniform in thickness, and yellowing thereof at the time when the coating film is exposed to sunlight can be reduced,

Examples of the aliphatic polyisocyanate compound include 1,6-hexamnethylene diisocyanate, 1,4-tetramnethylene diisocyanate, 1,5-pentamethylene diisocyanate, 2-methylpentane-1,5-diisocyanate, 3-methylpentane-1,5-diisocyanate, 2,4,4- or 2,2,4-trimethylhexamethylene diisocyanate, 2,6-diisocyanate nethylcaproate, lysine diisocyanate, trioxyethylene diisocyanate, isophorone diisocyanate, 1,4-bis(isocyanatomethyl)cyclohexane, 4,4′-methylenebis(cyclohexylisocyanate), methyl-2,4-cyclohexane diisocyanate, methyl-2,6-cyclohexane diisocyanate, 1,3-bis(isocyanatomethyl)cyclohexane, 1,3-his(isocyanatoethyl)cyclohexane, 1,4-bis(isocyanatoethyl)cyclohexane, 2,5- or 2,6-bis(isocyanatomethyl)norbornane (NBDI), and hydrogenated aromatic polyisocyanates.

Examples of the derivative of the aliphatic polyisocyanate compound include isocyanate-terminated prepolymers obtained by reacting an aliphatic polyisocyanate compound with a polyamine or polyol, allophanate-modified products, urea-modified products, carbodiimide-modified products, biuret-modified products, uretdione-modified products, isocyanurate-modified products, and products modified in water-dispersible type.

When the polyisocyanate compound (a) contains a derivative of an aliphatic polyisocyanate compound such as an isocyanate-terminated prepolymer or a modified product, a resulting coating film is improved in characteristics such as tensile strength. The isocyanate-terminated prepolymer can be obtained, for example, by reacting a polyisocyanate monomer with a polyol or a polyamine by a known method at 60 to 100° C. in a nitrogen gas atmosphere, and, as necessary, in the presence of a solvent or a known catalyst such as dioctyltin dilaurate.

The polyisocyanate compound (a) may contain, in addition to the aliphatic polyisocyanate compound, another isocyanate compound to meet intended performance such as physical properties or usable time. Examples thereof include 2,4-toluene diisocyanate, 2,6-toluene diisocyanate, diphenylmethane diisocyanate, xylylene diisocyanate, and 1,5-naphthylene diisocyanate, which are aromatic polyisocyanates.

In particular, when 1,6-hexamethylene diisocyanate (HDI) is used as the aliphatic polyisocyanate compound, the isocyanate compound other than HDI is preferably 2,4-toluene diisocyanate, 2,6-toluene diisocyanate, diphenylmethane diisocyanate, xylylene diisocyanate, 1,5-naphthylene diisocyanate, 1,5-pentamethylene diisocyanate, or 4,4′-methylenebis(cyclohexyl isocyanate), more preferably 2,4-toluene diisocyanate, 2,6-toluene diisocyanate, diphenylmethane diisocyanate, or 1,5-pentamethylene diisocyanate, from the viewpoint of compatibility with HDI and compatibility with the aromatic polyamine compound (b). Two or more of them may be used in combination.

The polyisocyanate compound (a) preferably has a viscosity of 3,000 mPa·s or less at 25° C. When the viscosity of the polyisocyanate compound (a) at 25° C. is more than 3,000 mPa·s, a coating material containing the polyurea resin composition may not be hand coated.

The polyisocyanate compound (a) preferably has an isocyanate group content of 5 to 30% NCO. When the ratio of isocyanate groups in the polyisocyanate compound (a) is lower than the above range, the polyurea resin composition may fail to have sufficient physical properties, and when the ratio is higher than the above range, the polyurea resin composition may fail to have sufficient usable time.

The aromatic polyamine compound (b) constituting the resin composition of the present invention is a compound represented by the following general formula (1):

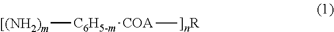

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

Examples of commercially available products of the polyether, of the aromatic amine compound (b) in which m=1, n:=2, and R is polyether include “ELASMER-1000P” (amine value: 80 to 90, manufactured by Kumiai Chemical Industry Co., Ltd.), “VERSALINK P-1000” (amine value: 80 to 90, manufactured by Air Products Japan, Inc), and “Porea SL-100A” (manufactured by Kumiai Chemical Industry Co., Ltd.).

The polyurea resin composition of the present invention may contain an amine compound other than the aromatic polyamine compound (b) for the purpose of adjusting coating film properties or the usable time.

Examples of such other amine compounds include aromatic amine compounds such as 4,4′-diamino-3,3′-dichlorodiphenylmethane and diethyltoluenediamine, polyetheramine compounds such as O,O′-bis(2-aminopropyl)propylene glycol, hexamethylenediamine and nonanediamine, Michael adducts (aspartate type amines) of an α,β-unsaturated carbonyl compound and a primary amine, and aliphatic amine compounds such as a reaction product of an epoxy compound and a primary amine. As the other amine compounds, both a primary amine and a secondary amine can be used.

The content of the other amine compound is preferably 0 to 20 parts by mass relative to 100 parts by mass in total with the aromatic polyamine compound (b). When the content of the other amine compound exceeds 20 parts by mass, the polyurea resin composition may not have a sufficient usable time.

In the resin composition of the present invention, the equivalence ratio (NCO/NH2) of the isocyanate groups of the polyisocyanate compound (a) to the amino groups of the aromatic polyamine compound (b) is preferably 0.6 to 1.5, more preferably 0.8 to 1.2, still more preferably 0.9 to 1.1, and particularly preferably 0.95 to 1.05. When the equivalence ratio is less than 0.6, the physical properties of a resulting polyurea resin coating film may be deteriorated. On the other hand, when the equivalence ratio is more than 1.5, the physical properties of a resulting polyurea resin coating film may be deteriorated, and side reactions such as foaming may readily occur.

The polyurea resin composition of the present invention preferably has a viscosity of 100 to 500,000 mPa·s, more preferably 500 to 300,000 mPa·s, and particularly preferably 1,000 to 200,000 mpa·s. When the viscosity is less than 100 mPa·s, it may be difficult to obtain a coating film having a sufficient thickness, and when the viscosity exceeds 500,000 mPa·s, it may be difficult to remove bubbles in the resin composition, or it may be difficult to perform coating work by hand coating.

The polyurea resin composition of the present invention preferably has a thixotropic index (TI) of 2 to 30, and more preferably 3 to 25. When the TI is less than 2, wall surface coatability may be deteriorated, and when the TI exceeds 30, a leveling property may be deteriorated.

The TI in the present invention is determined by (viscosity at spindle rotation speed of 0.3 rpm)/(viscosity at spindle rotation speed of 6 rpm) using a 3-type viscometer.

The polyurea resin composition of the present invention may contain a catalyst in order to improve the physical properties of a resulting coating film and to adjust the usable time and a curing temperature.

Specific examples of the catalyst include tertiary amines such as triethylamine, tributylamine, triethylenediamine, 2-dimethylaminoethyl ether, diazabicycloundecene and N-methylmorpholine; metal-based catalysts such as dibutyltin diacetate, dibutyltin laurate, 3-diacetoxytetrabutylstanoxane, tin octenate, tin chloride, tin butyl trichloride, bismuth trichloride, bismuth octenate, tetrakis(2-ethylhexyl) titanate, tetrabutoxytitanium, and metal salts of acetoacetic acid; quaternary ammonium salts such as tetramethylammonium chloride; and acidic compounds such as hydrochloric acid, sulfuric acid, acetic acid, succinic acid and trifluoromethanesulfonic acid.

The polyurea resin composition of the present invention may contain an additive, as necessary.

Examples of the additive include a basic inorganic compound, a pH adjuster, metal oxide fine particles, a tackifier, waxes, an ultraviolet absorber, a surface conditioner, a defoamer, a thixotropy imparting agent, a colorant, a dispersant, a filler, and a diluent. These may be used singly or two or more of them may be used in combination. The polyisocyanate compound (a) and the aromatic polyamine compound (b) may be mixed in advance.

The addition amount of the additive may be appropriately determined according to the purpose.

Examples of the basic inorganic compound include hydroxides, oxides, and (hydrogen) carbonate salts of alkali metals or alkaline earth metals such as calcium hydroxide, sodium hydroxide, magnesium hydroxide, calcium oxide, calcium carbonate, sodium carbonate, and sodium hydrogen carbonate. Among them, from the viewpoint of the influence on stability and viscosity, hydroxides of alkali metals or alkaline earth metals are more preferable.

Examples of the pH adjuster include organic acid salts of alkali metals or alkaline earth metals such as calcium acetate, sodium acetate, potassium acetate, calcium formate, sodium formate, potassium formate, calcium propionate, sodium propionate, and potassium propionate.

Examples of the metal oxide fine particles include titanium oxide, magnesium oxide, ferrous oxide, ferric oxide, triiron tetraoxide, aluminum oxide, vanadium oxide, and copper oxide.

Examples of the tackifier include polysaccharides such as xanthan gum and guar gum, rosin resins and derivatives thereof, terpene resins and derivatives thereof, aliphatic resins and derivatives thereof, and aromatic resins and derivatives thereof.

Examples of the waxes include paraffin-based waxes, amide-based waxes, olefin-based waxes, oxidized olefin-based waxes, montan wax, and copolymer waxes.

Examples of the ultraviolet absorber include hindered amine-based ultraviolet absorbers, cinnamic acid-based ultraviolet absorbers, benzophenone-based ultraviolet absorbers, triazine-based ultraviolet absorbers, and triazole-based ultraviolet absorbers.

Examples of the surface conditioner include silicone-based surface conditioners, acrylic polymer-based surface conditioners, vinyl-based surface conditioners, acetylene-based surface conditioners, fluorine-based surface conditioners, and alkylene oxide-based surface conditioners.

Examples of the defoamer include mineral oil-based defoamers, amide-based defoamers, metal soap-based defoamers, silicone-based defoamers, higher alcohols and derivatives thereof, fatty acid derivatives, and polyolefin-based defoamers. Among them, from the viewpoint of defoaming properties and chemical resistance, polyolefin-based defoaming agents are more preferable.

Examples of the thixotropy imparting agent include acrylic polymers, organic urea compounds and modified products thereof, fumed silica, bentonite, organic clays, and layered silicates. Among them, from the viewpoint of the effect versus the addition amount, organic urea compounds and modified products thereof are more preferable.

As a colorant, any of an inorganic pigment, an organic pigment, and a dye can be used. Examples of the inorganic pigment include red earth, loess, green earth, graphite, iron blue, zinc white, cobalt blue, viridian, and titanium white. Examples of the organic pigment include alkali blue, lithol red, disazo yellow, phthalocyanine blue, quinacridone red, and isoindoline yellow. Examples of the dye include madder, Suo, and indigo.

Examples of the dispersant include an acrylic polymer, polycarboxylic acid compounds, phosphonic acid compounds, sulfonic acid compounds and neutralized compounds thereof, quaternary ammonium salt compounds, amide compounds, and polyether compounds.

Examples of the filler include inorganic compounds such as calcium carbonate and calcium hydroxide, inorganic minerals such as talc, kaolin, apatite, and layered silicate, glass beads, glass fibers, and silica. Among them, talc, glass beads, and silica are preferable from the viewpoint of the addition amount and viscosity.

As the diluent, a common organic solvent can be used as long as it does not have reactivity with the polyisocyanate compound (a).

Examples of the organic solvent that can be used as the diluent include hydrocarbon compounds such as toluene, xylene, and cyclohexane, carbonyl compounds such as acetone, 2-butanone, and isophorone, and ester compounds such as ethyl acetate and butyl acetate. These may be used singly, or two or more of them may be mixed.

The content of the organic solvent in the polyurea resin composition is preferably 10% by mass or less. When the content of the organic solvent exceeds 10% by mass, not only the physical properties of a resulting coating film may be deteriorated, but also the advantages inherent in a polyurea resin that can be produced without any solvent may be lost.

### <Two-Component Mixed Polyurea Resin Composition Production Raw Material>

The two-component mixed polyurea resin composition production raw material of the present invention contains a component (A) containing a polyisocyanate compound (a) and a component (B) containing an aromatic polyamine compound (b), wherein the time to be taken until the viscosity value becomes twice the viscosity value measured in an organic-solvent-free state immediately after mixing the component (A) with the component (B) is 10 minutes or more.

Examples of the method for adjusting the time to be taken until the viscosity value doubles to 10 minutes or more include a method involving using a polyisocyanate compound (a) constituting the component (A) and containing an aliphatic polyisocyanate compound or a derivative thereof in an amount of more than 50% by mass, and using an aromatic polyamine compound (b) constituting the component (B) and containing a compound represented by the following general formula (1):

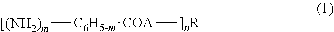

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

The polyisocyanate compound (a) preferably has a viscosity of 3,000 mPa·s or less at 25° C., and an isocyanate group content of 5 to 30% NCO,

### <Production of Polyurea Resin Composition>

The method for producing a polyurea resin composition of the present invention is a method involving: using a two-component mixed polyurea resin composition production raw material containing:
a component (A) containing a polyisocyanate compound (a) containing an aliphatic polyisocyanate compound or a derivative thereof in an amount of more than 50% by mass, and
a component (B) containing an aromatic polyamine compound (b) represented by the following general formula (1), and mixing the component (A) with the component (B)

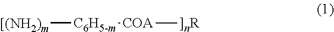

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

The component (A) and the component (B) may each contain the additive described above such as an organic solvent.

Since the two-component mixed polyurea resin composition production raw material is composed of the component (A) containing the polyisocyanate compound (a) and the component (B) containing the aromatic polyamine compound (b), the time (usable time) until the viscosity value becomes twice the viscosity value measured in an organic-solvent-free state immediately after mixing the component (A) with the component (B) can be adjusted to 10 minutes or more, and a polyurea resin composition having a long usable time can be obtained. The usable time is preferably 10 to 360 minutes, more preferably 20 to 180 minutes, and still more preferably 30 to 120 minutes.

### <Coating Film>

The coating film of the present invention is an applied coating material containing the polyurea resin composition of the present invention.

The coating film of the present invention can be formed by a coating method involving preparing a coating material by mixing a component (A) containing a polyisocyanate compound (a) containing an aliphatic polyisocyanate compound or a derivative thereof in an amount of more than 50% by mass with a component (B) containing an aromatic polyamine compound (b) represented by the following general formula (1), and applying the prepared coating material to an object to be coated,

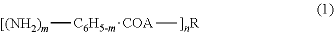

wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

Since the polyurea resin composition of the present invention has a sufficient curing time, a known method can be used as the method for applying the coating material, Although the method for applying the coating material may be appropriately selected depending on a desired thickness, a shape of an object to be coated, etc., examples thereof include such methods as dip coating (dipping, dipping coating), a wire bar, a Baker applicator, a gravure roll, potting, brush coating, roller coating, and trowel coating.

It is also possible to three-dimensionally form a cured product with a 3D printer or the like.

The thickness of the coating film may be appropriately chosen according to the intended physical properties, the material of a substrate, etc., but is usually preferably 10 to 10,000 in, more preferably 50 to 8,000 μm, and still more preferably 100 to 5,000 μm from the viewpoint of economic efficiency and physical properties.

As a method for obtaining the thickness described above, the application may be performed at one time, or may be performed separately in multiple times in layers.

Since the polyurea resin composition of the present invention has good physical strength, elongation rate, and chemical resistance, the polyurea resin composition can be suitably used as a protective layer for a substrate or a layer for preventing entry of a specific substance. Specific examples thereof include coated floors, linings, rooftop waterproofing, exterior wall coating, bridge floor slab waterproofing, waterproof paint, anticorrosive paint, protective paint inside and outside steel pipes, metal pipes and tanks, reinforcement and repair of buildings, protection of resin parts and metal parts, and storage ponds.

The polyurea resin composition of the present invention can also be combined with a plane body such as a fiber (including both long fiber and short fiber), a nonwoven fabric (including both long fiber and short fiber), a cloth, a metal gauze, a mesh, or a punching metal.

As the method for the combination, a known method can be used.

The application amount in combining with the plane body can be appropriately chosen according to the intended physical properties, the material of a substrate, etc., but is usually preferably 0.01 to 5 kg/m², more preferably 0.03 to 4 kg/m², and still more preferably 0.05 to 3 kg/m² from the viewpoint of economic efficiency and physical properties.

The polyurea resin composition of the present invention can also be poured into a metal frame to produce a molded article.

To improve the releasability between the metal frame and the polyurea resin composition, a release agent can also be used. As the release agent, a known release agent can be used, and the release agent may be applied to a metal frame before the polyurea resin composition is poured, or may be mixed when the polyisocyanate compound (a) and the aromatic polyamine compound (b) are mixed. When the release agent does not have reactivity with the polyurea resin composition, the release agent may be mixed in advance with one or both of the polyisocyanate compound (a) and the aromatic polyamine compound (b).

Since the polyurea resin composition of the present invention has reactivity at normal temperature, heating is usually unnecessary, but heating may be performed to accelerate curing after coating or the like. The curing temperature may be appropriately determined according to the application method and the curing time, but is preferably 40 to 80° C. from the viewpoint of safety.

As a device for heating the resin composition of the present invention, a known device may be used in view of the viscosity of the resulting polyurea resin, the shape of an adherend, etc. Specific examples of the heating device include a heating roller, a roller heater, a polyimide heater, an infrared radiation heater, an air high temperature heater, a heat gun, a dryer, a drying furnace, a baking furnace, a thermostatic dryer, and a thermostatic furnace.

The curing time may be appropriately chosen in view of the characteristics of the material, the machine, and the process, but is preferably less than 3 hours, more preferably less than 2 hours, and still more preferably less than 1 hour from the viewpoint of productivity.

To adjust the curing time, the catalyst described above may be utilized.

### EXAMPLES

The present invention will be described more concretely by way of examples and comparative examples, but the present invention is not limited to the following examples.

The raw materials used in the examples and the comparative examples are shown below. The raw materials were used as received without being subjected to purification or distillation.

<Polyisocyanate Compound (a)>
HDI: 1,6-Hexamethylene diisocyanate (manufactured by Tokyo Chemical Industry Co., Ltd., 49.9% NCO, viscosity: 3 mPa·s)
24A-100: Biuret-modified hexamethylene diisocyanate (“Duranate 24A-100” manufactured by Asahi Kasei Corporation, 23.5% NCO, viscosity: 1,800 mPa-s)
WL72-100: Water-dispersible type modified hexamethylene diisocyanate (“Duranate WL72-100” manufactured by Asahi Kasei Corporation, 21.3% NCO, viscosity: 1,000 mPa·s)
WT20-100: Water-dispersible type modified hexamethylene diisocyanate (“Duranate WT20-100” manufactured by Asahi Kasei Corporation, 14.1% NCO, viscosity: 1,400 mPa·s)
WB40-100: Water-dispersible type modified hexamethylene diisocyanate (“Duranate WB40-100” manufactured by Asahi Kasei Corporation, 16.6% NCO, viscosity: 4,500 mPa-s)
HXR: Nurate-modified hexamethylene diisocyanate (“Coronate HXR” manufactured by Tosoh Corporation, 21.9% NCO, viscosity: 1,500 mPa-s)
PP-45: Isocyanate-terminated HDI prepolymer (4.5% NCO, viscosity: 3,000 mPa·s) synthesized by the following method

47.2 parts by mass of polypropylene polyol (ADEKA POLYITHER P-1000 manufactured by ADEKA CORPORATION, molecular weight: 1000, bifunctional, hydroxyl value: 110) and 42.5 parts by mass of polyethylene glycol (Polyethylene Glycol 4,000 manufactured by Tokyo Chemical Industry Co., Ltd., molecular weight: 3200, bifunctional, hydroxyl value: 35) were mixed, and 10.2 parts by mass of 1,6 hexamethylene diisocyanate (Duranate 50M-HDI manufactured by Asahi Kasei Corporation, 50.0% NCO) was added thereto, and the mixture was mixed and stirred at 80° C. for 3 hours under a nitrogen atmosphere, and the intended product was thereby synthesized.
D-370N: Isocyanurate-modified 1,5-pentane diisocyanate (“STABIO D-370N” manufactured by Mitsui Chemicals, Inc., 25.0% NCO, viscosity: 2,000 mPa-s)
MR-200: Diphenylmethane diisocyanate (“Millionate MR-200” manufactured by Tosoh Corporation, 30.9% NCO, viscosity: not measurable because of being solid)
TDI: Toluene diisocyanate (2,4-, 2,6-mixture)(manufactured by Tokyo Chemical Industry Co., Ltd., 48.2% NCO, viscosity: 3 mPa·s)
IPDI: Isophorone diisocyanate (isomer mixture) (manufactured by Tokyo Chemical Industry Co., Ltd., 37.8% NCO, viscosity: 14 mPa·s)
   <Aromatic Polyamine Compound (b)>
SL-100A: Poly(tetramethylene/3-methyltetramethylene ether) glycol bis(4-aminobenzoate) (“Porea SL-100A” manufactured by Kumiai Chemical Industry Co., Ltd., amine value: 87 mg KOH/g, molecular weight: 1238, viscosity: 7,500 mPa·s)
250P: Polytetramethylene oxide-di-p-aminobenzoate (“ELASMER 250P” manufactured by Kumiai Chemical Industry Co., Ltd., amine value: 221 mg KOH/g, molecular weight: 488, viscosity: 205,000 mPa·s)
650P: Polytetramethylene oxide-di-p-aminobenzoate (“ELASMER 650P” manufactured by Kumiai Chemical Industry Co., Ltd., amine value: 126 mg KOI/g, molecular weight: 888, viscosity: 8,000 mPa·s)
1000P: Polytetramethylene oxide-di-p-aminobenzoate (“ELASMER 1000P” manufactured by Kumiai Chemical Industry Co., Ltd., amine value: 84 mg KOH/g, molecular weight: 1238, viscosity: 6,000 mPa·s)
HMBA: Heptamethylene-1,7-bis(4-aminobenzamide) (amine value: 317 mg KOH/g, molecular weight: 354, viscosity: 100,000 mPa·s) synthesized by the following method

With reference to the synthesis example of Japanese Patent Publication No. S60-32641, heptamethylene-1,7-bis(4-aminobenzamide) was synthesized by the same operation except that polytetramethylene glycol was changed to 1,7-heptamethylene diamine.

### <Other Amine Compounds>

DETDA: Mixture of 2,4-diamino-3,5-diethyltoluene and 2,6-diamino-3,5-diethyltoluene (“HARTCURE10” manufactured by Kumiai Chemical Industry Co., Ltd., amine value: 629 mg KOH/g, molecular weight: 178)
MBCA: Isomer mixture of 4,4′-methylenebis(cyclohexylamine) (manufactured by Tokyo Chemical Industry Co., Ltd., amine value: 534 mg KOH/g, molecular weight 210)
D-230: O,O′-Bis(2-aminopropyl)propylene glycol (“Polyetheramine D230” manufactured by Mitsui Fine Chemicals, Inc., amine value: 467 mg KOH/g, molecular weight: 230)

### <Additives>

PFA-250: Fatty acid amide wax (“DISPARLON PFA-250” manufactured by Kusumoto Chemicals, Ltd.)
1958: Phyllosilicate (“GARAMITIE 1958” manufactured by BYK)

Physical properties were measured by the following evaluation methods.

### (1) Isocyanate Group Content (% NCO)

The isocyanate group content was determined in accordance with the hydrochloric acid back titration method of di-n-butylamine of JIS K 7301.

### (2) Amine Value

The amine value was determined in accordance with the indicator titration method of JIS K 7237.

### (3) NCO/NH2 Equivalence Ratio

The NCO/NH2 equivalence ratio was calculated from the isocyanate group content and the amine value determined in the above (1) and (2).

### (4) Viscosity

The rotational viscosity (mPa-s) at a temperature of 25° C. was measured using a B-type viscometer (BROOKFIELD DIAL VISCOMETER Model LVT manufactured by BROOKFIELD ENGINEERING LABORATORIES, INC.).

### (5) Usable Time

The component (A) and the component (B) were placed in a glass container (100 mL, volume) and mixed quickly at 25° C. using a metallic stirring rod until they looked homogeneous. Thereafter, the same operation as in the viscosity measurement method described above was performed, and the time taken until the viscosity became twice the viscosity value immediately after the mixing was determined, and this was taken as the usable time. The usable time was rated according to the following criteria.
4: The usable time is 30 minutes or more and 120 minutes or less.
3: The usable time is equal to or more than 20 minutes and less than 30 minutes, or more than 120 minutes and less than or equal to 180 minutes.
2: The usable time is equal to or more than 10 minutes and less than 20 minutes, or more than 180 minutes and less than or equal to 360 minutes.
1: The usable time is less than 10 minutes, or more than 360 minutes.

Practically, the usable time needs to be rated as “2” or more, and is more preferably rated as “3” or more.

### (6) Thixotropic Index (TI)

The viscosity of a polyurea resin composition was measured at a spindle rotation speed of 6 rpm using a B-type viscometer “DV-I” manufactured by BROOKFIELD. Next, a polyurea resin having the same composition was newly prepared, and the viscosity of the polyurea resin composition was measured at a spindle rotation speed of 03 rpm. A TI was calculated by the following calculation formula.

(Viscosity at spindle rotation speed of 0.3 rpm)/(Viscosity at spindle rotation speed of 6 rpm)

Note that “-” indicates that the usable time was too short to measure.

### (7) Surface Uniformity of Coating Film

Leveling evaluation based on JIS K 5400 was performed and the presence or absence of air bubbles were visually evaluated.

### (Leveling Evaluation)

The component (A) and the component (B) were placed in a glass container (100 mL volume) and mixed quickly at 25° C. using a metallic stirring rod until they looked homogeneous. This mixture was spread on a glass plate sized 200×100×2 mm, and moved at an even speed while pressing a leveling tester (gap dimension: 4 mm) against the test plate. After curing it at 25° C. for 24 hours, when the unevenness of the coating film formed by the leveling tester was equal to or smaller than that of a reference sample, the tested sample was rated as “1”, and otherwise, the tested sample was rated as “0”. In addition, when the usable time was excessively short, leading to curing before the test, and the evaluation could not be performed, it was indicated as “-”. The reference sample was the cured product prepared in Example 1.

### (Presence or Absence of Bubbles)

The component (A) and the component (B) were placed in a glass container (100 mL volume) and mixed quickly at 25° C. using a metallic stirring rod until they looked homogeneous. This mixture was spread on a glass plate sized 200×100×2 mm and cured at 25° C. for 24 hours. The presence or absence of air bubbles in the resulting cured product was visually evaluated according to the following criteria.
4: Air bubbles cannot be confirmed, or the coating film is slightly cloudy due to fine air bubbles.
3: Cloudiness of the coating film can be confirmed due to fine bubbles.
2: Presence of air bubbles can be visually confirmed, but the thickness of the coating film remains uniform,
1: Craters due to air bubbles are present on the surface, so that the thickness is not uniform.
-: The usable time was excessively short, leading to curing before the test, and the evaluation cannot be performed.

Practically, the rating of “2” or more is required, and the rating is more preferably “3” or more.

### (8) Wall Surface Coatability (Sagging Property)

The wall surface coatability was evaluated on the basis of sagging property according to JIS K 5551.

A coating composition was applied to a metal plate sized 200 mm×150 mm using a sag tester (coating film thickness: 100, 200, 300, 400, 500 μm), and immediately, the metal plate was stood vertically with a thicker coating film located lower such that the orbit line of the sag tester was horizontal, and the applied coating composition was cured. The thickness with which no liquid flow (sagging) was observed was rated according to the following criteria.
1: The orbit line sagged even when the coating film thickness was 200 μm or less.
2: The orbit line did not sag up to a coating film thickness of 200 μm, and sagged with a coating film thickness of 300 μm.
3: The orbit line did not sag up to a coating film thickness of 300 μm, and sagged with a coating film thickness of 400 μm.
4: The orbit line did not sag up to a coating film thickness of 400 m, and sagged with a coating film thickness of 500 μm.
5: The orbit line did not sag even when the coating film thickness was 500 μm.

Practically, the rating of “2” or more is required, and the rating is more preferably “3” or more.

Note that “-” indicates that the usable time was too short to measure.

### (9) Tensile Strength and Elongation at Break

A polyurea resin composition was poured into a 30 cm×30 cm metal frame and cured at 25° C. for 24 hours, affording a cured product having a thickness of 1 mm. This was punched with a test piece punching blade, affording a dumbbell-shaped tensile test piece (type A1) defined in JIS K 7139. The tensile strength and elongation at break of this test piece were determined using a universal testing machine manufactured by INTESCO Co., Ltd. under the conditions of a temperature of 23° C., a test speed of 5 mm/min, and a distance between chucks of 115 mm. The evaluation was performed according to the following criteria.

### (Tensile Strength)

4: 30 MPa or more
3: 20 MPa or more and less than 30 MPa
2: 10 MPa or more and less than 20 MPa
1: Less than 10 MPa

### (Elongation at Break)

3: 5% or more
2: 3% or more and less than 5%
1: Less than 3%

Practically, a rating of “2” or more is required.

### (10) Acid Resistance

A polyurea resin composition was applied to a metal plate with a Baker type applicator so as to have a thickness of 1 mm, and was cured at 25° C. for 24 hours. Thereafter, the cured product was peeled off from the metal plate, cut into 20 mm×20 mm×1 mm to form a test piece, and immersed in a 10% by mass aqueous sulfuric acid solution at 25° C. for 60 days. Thereafter, the case where none of blistering, cracking, softening, and elution occurred in the test piece was rated as “1”, and the case where any one or more of them occurred was rated as “0”.

### (11) Organic Acid Resistance

A test piece obtained in the same manner as in the above (10) was immersed in a 5% by mass aqueous acetic acid solution at 25° C. for 60 days. Thereafter, the case where none of blistering, cracking, softening, and elution occurred in the test piece was rated as “1”, and the case where any one or more of them occurred was rated as “0”.

### (12) Alkali Resistance

A test piece obtained in the same manner as in the above (10) was immersed in a saturated aqueous calcium hydroxide solution at 25° C. for 60 days. Thereafter, the case where none of blistering, cracking, softening, and elution occurred in the test piece was rated as “1”, and the case where any one or more of them occurred was rated as “0”.

### (13) Yellowing Resistance

A polyurea resin composition was applied onto a concrete block with a Baker type applicator so as to have a thickness of 1 mm, and was cured at 25° C. for 24 hours. Thereafter, an accelerated weatherability test and an accelerated light fastness test were carried out by the xenon lamp method of JIS K 5600-7-7 (radiation intensity: 60 W/m², wavelength: 300 to 400 nm, cycle A, 300 hours). The test piece was confirmed before and after the test, and the case where yellowing was not confirmed was rated as “1”, and the case where yellowing was confirmed was rated as “0”.

### Example 1

A component (A) in which the polyisocyanate compound (a) was HDI and a component (B) in which the aromatic polyamine compound (b) was SL-100A were mixed at 25° C. with a metal stirring rod such that the equivalence ratio (NCO/NH2) was 1.05 until a uniform appearance was obtained.

Thereafter, the resulting polyurea resin composition was applied to a substrate by the method described in the evaluation test described above, and was cured, affording a coating film.

### Examples 2 to 23, Comparative Examples 1 to 6

In the same manner as in Example 1 except that the component (A) and the component (B) were prepared so as to have the configurations indicated in Tables 1 and 3, the component (A) and the component (B) were mixed, and a polyurea resin composition and a coating film were obtained.

### Examples 24 to 28

A polyurea resin composition and a coating film were obtained in the same manner as in Example 3 except that PFA-250 or 1958 as an additive was mixed so as to have the content indicated in Table 3.

The constitution of the raw materials for polyurea resin composition production in Examples and Comparative Examples and the characteristics of the obtained polyurea resin compositions are shown in Tables 1 to 4.

TABLE 1

| Configuration of two-component mixed polyurea resin composition production raw material | | | | | | | | | | | | |
|---|---|---|---|---|---|---|---|---|---|---|---|---|
| Component (A) | | | | | | | | | | | | |
| Polyisocyanate compound (a) | | | | | | | | | | | | |
| Aliphatic | | | | | | | | | | | | |
| polyisocyanate | | | | Component (B) | | | | | | | | |
| compound or | | Aromatic | | Aromatic | | | | | | Additive | | |
| derivative | | polyisocyanate | | polyamine | | Other amine | | Organic | | Thixotropy | | |
| thereof | | compound | | compound (b) | | compound | | solvent | | imparting agent | | Equivalence |
| | % by | | % by | | % by | | % by | | parts by | | parts by | ratio |
| Type | mass | Type | mass | Type | mass | Type | mass | Type | mass* | Type | mass* | (NCO/NH2) |

| | | | | | | | | | | |
|---|---|---|---|---|---|---|---|---|---|---|
| Example | 1 | HDI | 100 | | | SL-100A | 100 | | | 1.05 |
| | 2 | 24A-100 | 100 | | | SL-100A | 100 | | | 1.05 |
| | 3 | WL72-100 | 100 | | | SL-100A | 100 | | | 1.05 |
| | 4 | WT20-100 | 100 | | | SL-100A | 100 | | | 1.05 |
| | 5 | WB40-100 | 100 | | | SL-100A | 100 | | | 1.05 |
| | 6 | HXR | 100 | | | SL-100A | 100 | | | 1.05 |
| | 7 | PP-45 | 100 | | | SL-100A | 100 | | | 1.05 |
| | 8 | D-370N | 100 | | | SL-100A | 100 | | | 1.05 |
| | 9 | IPDI | 100 | | | SL-100A | 100 | | | 1.05 |
| | 10 | WL72-100 | 90 | MR-200 | 10 | SL-100A | 100 | | | 1.05 |
| | 11 | WL72-100 | 70 | MR-200 | 30 | SL-100A | 100 | | | 1.05 |
| | 12 | WL72-100 | 90 | TDI | 10 | SL-100A | 100 | | | 1.05 |
| | 13 | WL72-100 | 100 | | | 250P | 100 | | | 1.05 |
| | 14 | WL72-100 | 100 | | | 650P | 100 | | | 1.05 |
| | 15 | WL72-100 | 100 | | | 1000P | 100 | | | 1.05 |
| | 16 | WL72-100 | 100 | | | HMBA | 100 | | | 1.05 |
| | 17 | WL72-100 | 100 | | | SL-100A | 90 | DETDA | 10 | 1.05 |
| | 18 | WL72-100 | 100 | | | SL-100A | 80 | DETDA | 20 | 1.05 |

TABLE 2

| | | Characteristics of polyurea resin composition | | | | | | | | | | | | |
|---|---|---|---|---|---|---|---|---|---|---|---|---|---|---|
| | | Viscosity | | | | Surface | | | | | | Organic | | |
| | | immediately | | | | uniformity | | Wall | | | Acid | acid | Alkali | Yellowing |
| | | after mixing | Usable time | | | | Air | surface | Tensile | Elongation | resis- | resis- | resis- | resis- |
| | | mPa · s | minutes | Rating | TI | Leveling | bubbles | coatability | strength | at break | tance | tance | tance | tance |
| Example | 1 | 4400 | 10 | 2 | 1.1 | 1 | 2 | 2 | 2 | 3 | 1 | 1 | 1 | 1 |
| | 2 | 3400 | 25 | 3 | 1.7 | 1 | 3 | 3 | 3 | 3 | 1 | 1 | 1 | 1 |
| | 3 | 3200 | 60 | 4 | 2.1 | 1 | 4 | 4 | 4 | 3 | 1 | 1 | 1 | 1 |
| | 4 | 3400 | 39 | 4 | 1.7 | 1 | 3 | 3 | 3 | 3 | 1 | 1 | 1 | 1 |
| | 5 | 5700 | 14 | 2 | 1.8 | 1 | 2 | 4 | 3 | 3 | 1 | 1 | 1 | 1 |
| | 6 | 3500 | 25 | 3 | 1.9 | 1 | 3 | 4 | 3 | 3 | 1 | 1 | 1 | 1 |
| | 7 | 6000 | 192 | 2 | 1.5 | 1 | 2 | 3 | 2 | 3 | 1 | 1 | 1 | 1 |
| | 8 | 2700 | 15 | 2 | 2.2 | 1 | 3 | 4 | 3 | 3 | 1 | 1 | 1 | 1 |
| | 9 | 2000 | 55 | 4 | 1.1 | 1 | 2 | 2 | 3 | 2 | 1 | 1 | 1 | 1 |
| | 10 | 3000 | 30 | 4 | 1.3 | 1 | 3 | 3 | 3 | 3 | 1 | 1 | 1 | 1 |
| | 11 | 2700 | 18 | 2 | 1.2 | 1 | 2 | 3 | 3 | 3 | 1 | 1 | 1 | 1 |
| | 12 | 3000 | 38 | 4 | 1.3 | 1 | 3 | 3 | 3 | 3 | 1 | 1 | 1 | 1 |
| | 13 | 17000 | 20 | 3 | 1.7 | 1 | 4 | 4 | 4 | 3 | 1 | 1 | 1 | 1 |
| | 14 | 8400 | 42 | 4 | 1.7 | 1 | 4 | 3 | 3 | 3 | 1 | 1 | 1 | 1 |
| | 15 | 2400 | 55 | 4 | 1.7 | 1 | 4 | 3 | 3 | 3 | 1 | 1 | 1 | 1 |
| | 16 | 8600 | 43 | 4 | 1.6 | 1 | 4 | 3 | 3 | 3 | 1 | 1 | 1 | 1 |
| | 17 | 3200 | 43 | 4 | 1.7 | 1 | 3 | 4 | 3 | 3 | 1 | 1 | 1 | 1 |
| | 18 | 3100 | 32 | 4 | 1.7 | 1 | 3 | 4 | 3 | 3 | 1 | 1 | 1 | 1 |

TABLE 3

| Configuration of two-component mixed polyurea resin composition production raw material | | | | | | | | | | | | |
|---|---|---|---|---|---|---|---|---|---|---|---|---|
| Component (A) | | | | | | | | | | | | |
| Polyisocyanate compound (a) | | | | | | | | | | | | |
| Aliphatic | | | | | | | | | | | | |
| polyisocyanate | | | | Component (B) | | | | | | | | |
| compound or | | Aromatic | | Aromatic | | | | | | Additive | | |
| derivative | | polyisocyanate | | polyamine | | Other amine | | Organic | | Thixotropy | | |
| thereof | | compound | | compound (b) | | compound | | solvent | | imparting agent | | Equivalence |
| | % by | | % by | | % by | | % by | | parts by | | parts by | ratio |
| Type | mass | Type | mass | Type | mass | Type | mass | Type | mass* | Type | mass* | (NCO/NH2) |

| | | | | | | | | | | | | | |
|---|---|---|---|---|---|---|---|---|---|---|---|---|---|
| Example | 19 | WL72-100 | 100 | | | SL-100A | 100 | | | | | | 1.50 |
| | 20 | WL72-100 | 100 | | | SL-100A | 100 | | | | | | 1.20 |
| | 21 | WL72-100 | 100 | | | SL-100A | 100 | | | | | | 0.80 |
| | 22 | WL72-100 | 100 | | | SL-100A | 100 | | | | | | 0.60 |
| | 23 | WL72-100 | 100 | | | SL-100A | 100 | | Toluene | 10 | | | 1.05 |
| | 24 | WL72-100 | 100 | | | SL-100A | 100 | | | | PFA-250 | 1 | 1.05 |
| | 25 | WL72-100 | 100 | | | SL-100A | 100 | | | | PFA-250 | 5 | 1.05 |
| | 26 | WL72-100 | 100 | | | SL-100A | 100 | | | | 1958 | 1 | 1.05 |
| | 27 | WL72-100 | 100 | | | SL-100A | 100 | | | | 1958 | 5 | 1.05 |
| | 28 | WL72-100 | 100 | | | SL-100A | 100 | | | | 1958 | 10 | 1.05 |
| Comparative | 1 | WL72-100 | 50 | MR-200 | 50 | SL-100A | 100 | | | | | | 1.05 |
| Example | 2 | | 0 | MR-200 | 100 | SL-100A | 100 | | | | | | 1.05 |
| | 3 | | 0 | TDI | 100 | SL-100A | 100 | | | | | | 1.05 |
| | 4 | WL72-100 | 100 | | | | 0 | DETDA | | | | | 1.05 |
| | 5 | WL72-100 | 100 | | | | 0 | MBCA | | | | | 1.05 |
| | 6 | WL72-700 | 100 | | | | 0 | D-230 | | | | | 1.05 |

*Parts by mass per 100 parts by mass of polyurea resin composition

TABLE 4

| | | Characteristics of polyurea resin composition | | | | | | | | | | | | |
|---|---|---|---|---|---|---|---|---|---|---|---|---|---|---|
| | | Viscosity | | | | Surface | | Wall | | Elon- | | Organic | | |
| | | immediately | | | | uniformity | | surface | | gation | Acid | acid | Alkali | Yellowing |
| | | after mixing | Usable time | | | | Air | coata- | Tensile | at | resis- | resis- | resis- | resis- |
| | | mPa · s | minutes | Rating | TI | Leveling | bubbles | bility | strength | break | tance | tance | tance | tance |
| Example | 19 | 1800 | 182 | 2 | 1.8 | 1 | 3 | 3 | 2 | 2 | 1 | 1 | 1 | 1 |
| | 20 | 3100 | 69 | 4 | 2.1 | 1 | 3 | 4 | 3 | 3 | 1 | 1 | 1 | 1 |
| | 21 | 4300 | 67 | 4 | 2.1 | 1 | 3 | 4 | 3 | 3 | 1 | 1 | 1 | 1 |
| | 22 | 6700 | 137 | 3 | 1.7 | 1 | 2 | 3 | 2 | 3 | 1 | 1 | 1 | 1 |
| | 23 | 1000 | 85 | 4 | 1.5 | 1 | 3 | 3 | 2 | 3 | 1 | 1 | 1 | 1 |
| | 24 | 6800 | 63 | 4 | 4.0 | 1 | 4 | 4 | 4 | 3 | 1 | 1 | 1 | 1 |
| | 25 | 9200 | 75 | 4 | 16.1 | 1 | 4 | 4 | 4 | 3 | 1 | 1 | 1 | 1 |
| | 26 | 9500 | 77 | 4 | 10.9 | 1 | 4 | 4 | 4 | 3 | 1 | 1 | 1 | 1 |
| | 27 | 15700 | 90 | 4 | 28.5 | 1 | 4 | 4 | 4 | 3 | 1 | 1 | 1 | 1 |
| | 28 | 35000 | 97 | 4 | 33.9 | 1 | 3 | 4 | 3 | 3 | 1 | 1 | 1 | 1 |
| Comparative | 1 | 2000 | 1 | 1 | 1.0 | 0 | 1 | 1 | 3 | 3 | 1 | 1 | 1 | 0 |
| Example | 2 | Unmeasurable | 1 or less | 1 | — | 0 | 1 | — | 3 | 3 | 1 | 1 | 1 | 0 |
| | 3 | Unmeasurable | 1 or less | 1 | — | 0 | 1 | — | 3 | 3 | 1 | 1 | 1 | 0 |
| | 4 | Unmeasurable | 1 or less | 1 | — | — | — | — | 3 | 1 | 1 | 0 | 0 | 0 |
| | 5 | Unmeasurable | 1 or less | 1 | — | — | — | — | 3 | 3 | 1 | 0 | 1 | 1 |
| | 6 | Unmeasurable | 1 or less | 1 | — | — | — | — | 1 | 3 | 0 | 0 | 0 | 1 |

The polyurea resin compositions of Examples had a long usable time, and were capable of being manually applied. In addition, when they were made into coating films, the surfaces thereof were uniform. When the aliphatic polyisocyanate compound constituting the polyurea resin composition was hexamethylene diisocyanate or a modified product of an isocyanate compound, the resulting coating film was more superior in uniformity and various physical properties when formed into the coating film.

In Comparative Example 1 to 3, in which the polyisocyanate compound constituting the polyurea resin composition did not contain an aliphatic polyisocyanate compound or the content of a aliphatic polyisocyanate compound was small, and Comparative Examples 4 to 6, in which the polyurea resin composition did not contain an aromatic polyamine compound, there were cases where the usable time was short and it was difficult to perform manual coating work, and the resulting coating film did not satisfy all of the characteristics such as acid resistance, organic acid resistance, alkali resistance, and yellowing resistance.

1. A two-component mixed polyurea resin composition production raw material comprising a component (A) containing a polyisocyanate compound (a) and a component (B) containing an aromatic polyamine compound (b), wherein
the two-component mixed polyurea resin composition production raw material has the usable time until a viscosity value becomes twice a viscosity value measured in an organic-solvent-free state immediately after mixing the component (A) with the component (B) of 10 minutes or more.

2. The two-component mixed polyurea resin composition production raw material according to claim 1, wherein
the polyisocyanate compound (a) contains an aliphatic polyisocyanate compound or a derivative thereof in an amount of more than 50% by mass, and
the aromatic polyamine compound (b) contains a compound represented by the following general formula (1): 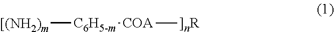
wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

3. The two-component mixed polyurea resin composition production raw material according to claim 1, wherein the polyisocyanate compound (a) has a viscosity of 3,000 mPa·s or less at 25° C.

4. The two-component mixed polyurea resin composition production raw material according to claim 1, wherein the polyisocyanate compound (a) has an isocyanate group content of 5 to 30% NCO.

5. A polyurea resin composition comprising:
a component (A) containing a polyisocyanate compound (a); and
a component (B) containing an aromatic polyamine compound (b), wherein
all of the following conditions (1) to (3) are satisfied:
(1) the usable time until a viscosity value becomes twice a viscosity value measured in an organic-solvent-free state immediately after mixing the component (A) with the component (B) is 10 minutes or more;
(2) the polyisocyanate compound (a) has a viscosity of 3,000 mPa·s or less at 25° C.;
(3) the polyisocyanate compound (a) contains an aliphatic isocyanate compound or a derivative thereof.

6. The polyurea resin composition according to claim 5, wherein the thixotropic index (TI) is 2 to 30.

7. The polyurea resin composition according to claim 5, wherein
the polyisocyanate compound (a) contains an aliphatic polyisocyanate compound or a derivative thereof in an amount of more than 50% by mass, and
the aromatic polyamine compound (b) contains a compound represented by the following general formula (1): 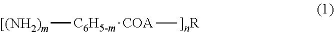
wherein R represents an n-valent polyalkylene, polyalkylene ether or polyalkylene polyester having an average molecular weight of 80 or more, and A represents an oxygen atom or an amino group, provided that the polyalkylene may contain an unsaturated bond; m represents an integer of 1 to 3, and n represents an integer of 2 to 4.

8. The polyurea resin composition according to claim 5, wherein the polyisocyanate compound (a) has an isocyanate group content of 5 to 30% NCO.

9. The polyurea resin composition according to claim 5, further comprising an organic solvent, wherein a content of the organic solvent in the polyurea resin composition is 10% by mass or less.

10. A method for producing a polyurea resin composition, comprising mixing a component (A) containing a polyisocyanate compound (a) containing an aliphatic polyisocyanate compound or a derivative thereof in an amount of more than 50% by mass with a component (B) containing an aromatic polyamine compound (b) represented by the following general formula (1): 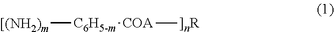
wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

11. A coating material comprising the polyurea resin composition according to claim 5.

12. A coating method comprising:
preparing a coating material by mixing a component (A) containing a polyisocyanate compound (a) containing an aliphatic polyisocyanate compound or a derivative thereof in an amount of more than 50% by mass with a component (B) containing an aromatic polyamine compound (b) represented by the following general formula (1); and
applying the prepared coating material to an object to be coated, 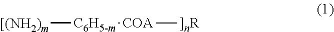
wherein R represents an n-valent polyalkylene, polyalkylene ether or polyalkylene polyester having an average molecular weight of 80 or more, and A represents an oxygen atom or an imino group, provided that the polyalkylene may contain an unsaturated bond; m represents an integer of 1 to 3, and n represents an integer of 2 to 4.

13. The coating method according to claim 12, wherein the method of applying the coating material is brush coating, roller coating, or trowel coating.

14. A coating film comprising the coating material according to claim 11 applied.
